(19) United States
(12) Patent Application Publication
(10) Pub. No.: US 2005/0142333 A1
(43) Pub. Date: Jun. 30, 2005

(54) Method of manufacturing composite vehicle panels

(76) Inventors: John C. Montagna, Metamora, MI (US); Leslie E. Smith, Lapeer, MI (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/748,469

(22) Filed: Dec. 30, 2003

(51) Int. Cl. B32B 1/00

(52) U.S. Cl. 428/180; 428/182

(57) ABSTRACT

A method of fabricating composite vehicle panels includes the steps of forming a first, lower panel with a plurality of raised features having coplanar end portions, forming a second, upper panel having a depending peripheral lip adapted to engage a periphery of the first panel, placing an adhesive on the end portions of the raised features of the first panel and securing said panels together at the raised features and about the peripheral lip.

### BACKGROUND OF THE INVENTION

The invention relates generally to a method for manufacturing a vehicle panel and more particularly to a method of fabricating and assembling composite panels for use on motor vehicles such as pickup trucks, crossover vehicles and the like.

The continuing popularity of pickup trucks and crossover vehicles having a passenger compartment smaller than an SUV but also including a truck bed has created a market for accessories for these vehicles. One of the most popular accessories is a closure or tonneau cover for the truck bed. Characterized most simply, the tonneau cover is a horizontally disposed structure which covers the truck bed and is disposed upon and engages the rails of the truck bed.

There the simplicity ends because this seemingly simple device is subject to many structural and operational requirements. First of all, the closure or tonneau cover must generally not be stationary but must be movable to permit access to the truck or bed by being hinged along its juncture with the front wall rail of the truck bed or by including hinges pivoting along the longitudinal axis of the truck bed to provide access into the truck bed from either the left side of the truck, the right side of the truck or both. Given the likelihood of hauling valuable cargo in the truck bed, the tonneau cover must also be amenable to being locked to provide a reasonable degree of security.

Structurally, the cover must be strong and dimensionally stable. Since the cover will be subjected to typical ambient extremes of temperature as well as heating from the sun and weight from heavy snow or an object placed thereupon, it must exhibit exceptional strength and ruggedness.

Cosmetically, the product is demanding as well since the product finish must accept paint and result in a surface appearance rivaling that of painted sheet metal in order to be acceptable to purchasers.

Last of all, given the size of such tonneau covers, frequently four feet by six feet and sometimes larger, it is desirable that they exhibit reduced weight in order to not adversely impact the gas mileage obtained by the vehicle.

All of the foregoing requirements are addressed by the method and resulting product described more fully below.

### SUMMARY OF THE INVENTION

A method of fabricating composite vehicle panels includes the steps of forming a first, lower panel with a plurality of raised features having coplanar end portions, forming a second, upper panel having a depending peripheral lip adapted to engage a periphery of the first panel, placing an adhesive on the end portions of the raised features of the first panel and securing said panels together at the raised features and about the peripheral lip.

Thus it is an object of the present invention to provide a method of fabricating composite vehicle panels.

It is a further object of the present invention to provide a method of fabricating composite vehicle panels having a lower panel with a plurality of raised features which are secured by an adhesive to an upper panel.

It is a still further object of the present invention to provide a method of fabricating composite vehicle panels which are secured together around their periphery.

It is a still further object of the present invention to provide a composite vehicle panel wherein features projecting from a lower panel take the form of cone frustums, elongate ribs or channels and the like.

Further objects and advantages of the present invention will become apparent by reference to the following description of the preferred embodiment and appended drawings wherein like reference numbers refer to the same component, element, or feature.

### BRIEF DESCRIPTION OF THE DRAWINGS

FIG. 1 is a perspective view of a composite panel according to the present invention utilized as a tonneau cover and disposed over the bed of a pickup truck;

FIG. 2 is an enlarged, fragmentary view in partial section of a composite vehicle panel according to the present invention utilized as a tonneau cover, taken along like 2-2 of FIG. 1;

FIG. 3 is an enlarged, fragmentary, sectional view of upper and lower mold segments which illustrates production of a first or lower panel according to the present invention;

FIG. 4 is a perspective view of an adhesive applying step of the method of fabricating a composite panel according to the present invention;

FIG. 5 is an enlarged, fragmentary, sectional view of upper and lower mold segments which illustrates production of a second upper panel according to the present invention;

FIG. 6 is a fragmentary, sectional view of a mold for undertaking the assembly step of a method of fabricating composite vehicle panels according to the present invention;

FIG. 7 is an enlarged fragmentary view in partial section of a first alternate embodiment of a composite vehicle panel according to the present invention utilized as a tonneau cover;

FIG. 8 is a perspective view of an adhesive applying step according to the method of fabricating composite vehicle panels according to the present invention;

FIG. 9 is a fragmentary, sectional view illustrating the assembly of the upper and lower panels of a first alternate embodiment composite vehicle panel according to the present invention;

FIG. 10 presents a final fabrication step of a first alternate embodiment composite vehicle panel according to the present invention;

FIG. 11 is an enlarged fragmentary view in partial cross section of a second alternate embodiment of a composite vehicle panel according to the present invention utilized as a tonneau cover;

FIG. 12 is a perspective view of a second alternate embodiment first or lower panel for a composite vehicle panel according to the present invention; and

FIG. 13 is an enlarged, fragmentary sectional view of a portion of the first, lower panel of a composite vehicle panel taken along line 13-13 of FIG. 12.

### DETAILED DESCRIPTION OF THE PREFERRED AND ALTERNATE EMBODIMENTS

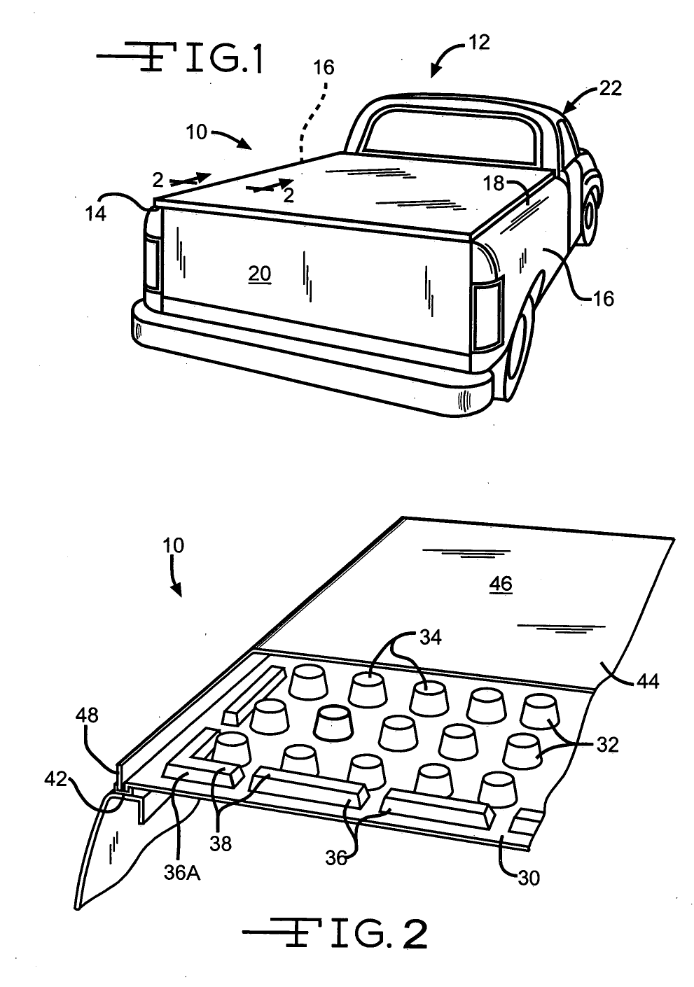

Referring now to FIG. 1, a composite vehicle panel is illustrated and generally designated by the reference number 10. The composite vehicle panel 10 illustrated is generally referred to as a tonneau cover but may be one of several different vehicular panels such as a floorboard, a door panel, a roof panel or other generally planar body panel for use on or with a motor vehicle such as a pickup truck 12. The composite panel 10 is fitted over the open top of a truck bed 14 having a pair of opposed, spaced apart conventional sidewalls 16 which are connected by a front wall (not illustrated) and a horizontal bottom panel (also not illustrated). The pickup truck 12 also includes a tailgate assembly 20 and a cab 22. It will be appreciated that the pickup truck 12 illustrated is conventional and representative of a broad range of pickup trucks, SUV's and crossover vehicles having an exterior cargo bed.

Referring now to FIG. 2, the composite vehicle panel 10 includes a first or lower panel 30 having a plurality of spaced apart upwardly extending features or projections 32 which may define frusto-conical shapes or other polygonal tapering shapes having flat, coplanar upper surfaces 34. Generally adjacent the periphery of the first or lower panel 30 are elongate, shallower features or projections 36 having upper planar surfaces 38 which are at a reduced height relative to the surfaces 34. The features or projections 36 are preferably rectangular and disposed generally parallel to and proximate an edge of the lower panel 30. The elongate features or projections 36 may include right angle features 36A adjacent the corners of the panel 30. The tapering walls of the features or projections 32 and 36 are configured primarily to assist removal of the lower panel 30 from molding equipment and, as such, may exhibit a draft of 5° to 10° or more or less if desired. The first or lower panel 30 also includes a downturned or depending peripheral edge or lip 42.

The composite vehicle panel 10 also includes second or upper panel 44 which is preferably a planar region 46 and includes a peripheral downturned edge or lip 48 having inside dimensions, i.e., length, width and radiused corners, equal to the outside dimensions adjacent the lip 42 of the second or lower panel 30 such that the first or lower panel 30 may fit snugly and without strain into the second or upper panel 44, as illustrated in FIG. 2.

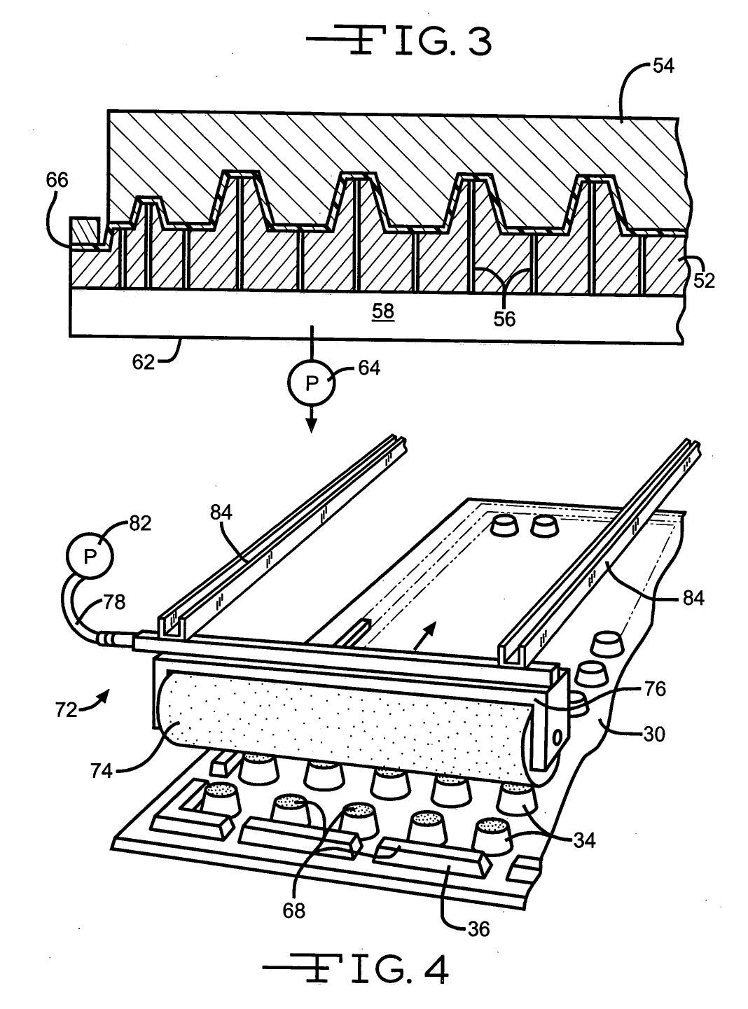

Turning now to FIGS. 3, 4 and 5, the steps of manufacturing and assembling the composite vehicle panel 10 will now be described. Turning first to FIG. 3, a conventional thermoforming mold having a first or lower male mold segment 52 and, optionally, a second or upper matching female mold segment 54 are utilized. Whether the second or upper matching female mold segment 54 is utilized or the lower panel 30 is vacuum formed only against the first or lower mold segment 52 is determined by the characteristics of the material being formed and the desired amount of detail on the lower panel 30. The lower male mold segment 52 preferably includes a plurality of vacuum passageways 56 which communicate from the surface of the mold segment 52 to a plenum 58 which is defined by a plenum wall 62 on the back side of the male mold segment 52. A vacuum pump 64 draws a partial vacuum in the plenum 58 such that air is drawn through the passageways 56 in accordance with conventional practice.

A sheet of thermoformable material 66 is placed between the mold segments 52 and 54, the vacuum pump 64 is activated and the mold segments 52 and 54 are drawn together, forming the sheet of thermoformable material 66 into the first or lower panel 30 illustrated in FIGS. 2 and 4. The thermoformable material 66 may be high density polyethylene (HDPE), thermoplastic polyolefin (TPO) or one of several other similar thermoplastic materials such as acrylonitrile-butadiene-styrene (ABS). Subsequent to molding, the mold segments 52 and 54 are separated and the formed lower panel 30 is removed.

Turning now to FIG. 4, the thermoformed first or lower panel 30 is then positioned with the coplanar surfaces 34 up such that adhesive 68 may be applied thereto. Preferably, adhesive 68 is applied through the agency of a movable roller assembly 72. A freely rotatable, horizontally disposed elongate roller 74 is provided with the adhesive 68 through a horizontal elongate nozzle 76 which is preferably disposed above and proximate the roller 74. The elongate nozzle 76 may be supplied with liquid adhesive through a tube or pipe 78 from a suitably disposed pump 82. The roller assembly 72 is preferably suspended upon a pair of spaced apart, parallel tracks 84 which maintain the roller 74 at an appropriate vertical location such that the roller 74 contacts the coplanar surfaces 34 and applies adhesive thereto as it is translated over the panel 30. The roller assembly 74 may be translated manually or may be coupled to a suitable bi-directional, semi-automatic or automatic drive system (not illustrated).

Referring now to FIG. 5, the second or upper panel 46 is formed in a mold assembly having a first or lower mold assembly 88 having vacuum passageways 90 and a second optional upper mold assembly 92. The mold cavity which is occupied by a sheet of thermoplastic material 94 is molded into the second or upper panel 44 which is primarily planar but includes a depending peripheral lip 48 all of which is formed in the proper size by the mating mold segments 88 and 92. Subsequent to molding the panel 44, the mold segments 88 and 92 are separated and the second or upper panel 44 is removed therefrom.

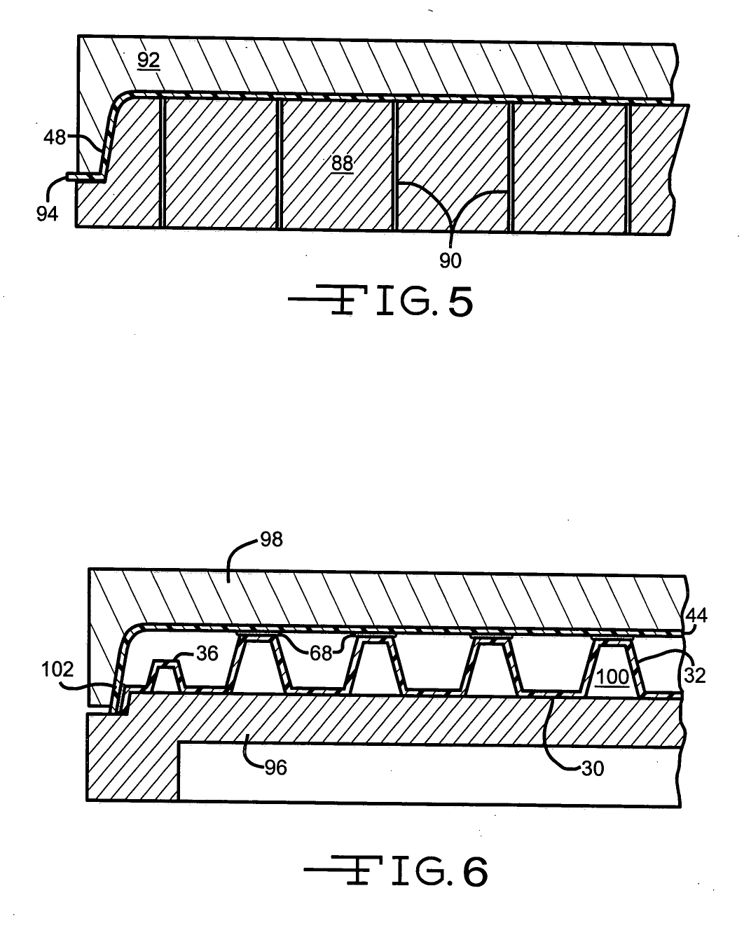

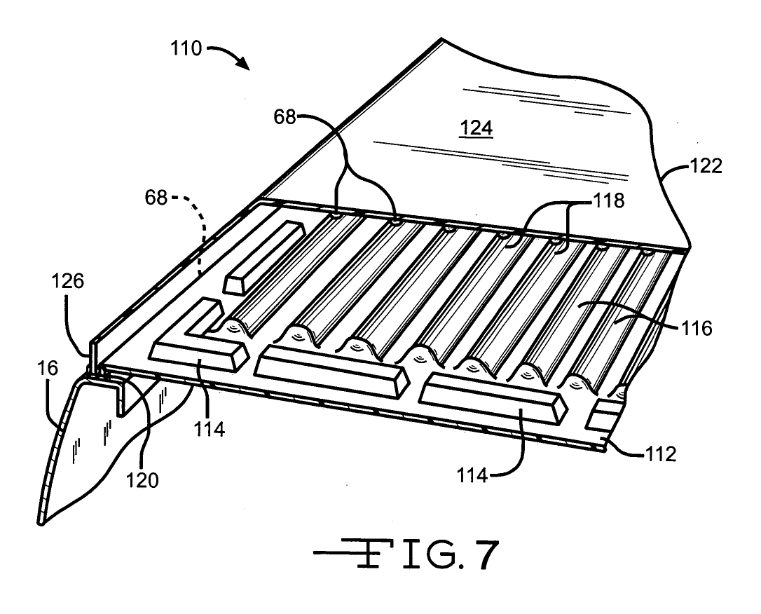

Referring now to FIG. 6, the first or lower panel 30 having adhesive 68 applied to the surfaces 34 and the second or upper panel 44 are secured together. The panels 30 and 44 are disposed in a first or lower mold segment 96 and a second or upper mold segment 98 which defines a mold cavity 100 having a narrow peripheral margin 102 which receives the lips or flanges 42 and 48 of the panels 30 and 44. The spacing between the upper surface of the lower mold segment 96 and the lower surface of the upper mold segment 98 is such that closure of the mold segments 96 and 98 compresses the first and second panels 30 and 44 such that the adhesive 68 bonds the two panels together at the points of contact of the upper portions 34 of the features or projections 32 and about the periphery of the panels at the lips or flanges 42 and 48.

Referring now to FIG. 7, a first alternate embodiment of a composite vehicle panel utilized as a tonneau cover is illustrated and generally designated by the reference number 110. The first alternate embodiment composite vehicle panel 110 includes a first or lower panel 112 having a plurality of reduced height, elongated, rectangular features or projections 114 which are parallel to and extend about the periphery of the panel 112. Extending across the center region of the panel 112 or a plurality of spaced apart convolutions or corrugations 116 which are disposed in parallel and extend from proximate the rectangular features or projections 114 along one edge of the panel 112 to similar features or projections 114 extending along the opposite edge of the panel 112. The convolutions or corrugations 116 are taller than the rectangular features or projections 114 having highest or uppermost parallel regions 118. The first or lower panel 112 also includes a peripheral depending flange or lip 120 which extends fully about its periphery. The first alternate embodiment composite panel110 also includes a second or upper panel 122 having a planar central region 124 or depending flange or lip 126 extending fully about its periphery. Once again, the inside dimensions of the second or upper panel 122 adjacent the edge of the depending flange or lip 126 are equal to the outside dimensions of the first or lower panel 112 at its depending flange or lip 120.

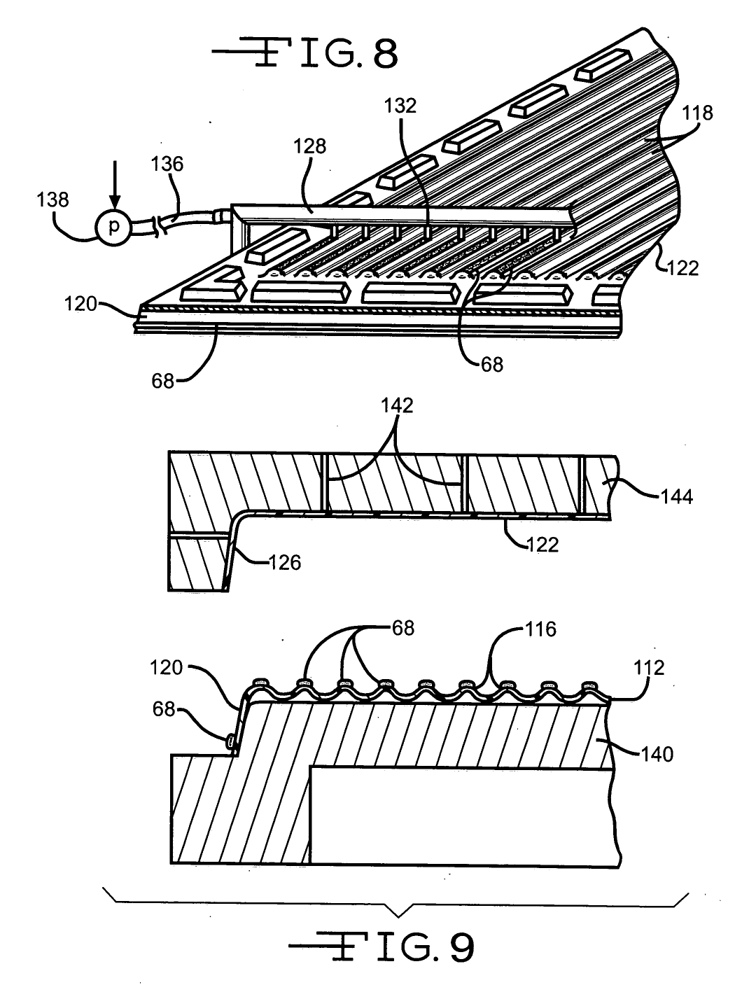

As illustrated in FIG. 8, production of the first or lower panel 112 and of the second or upper panel 122 is essentially the same as production of the panels 30 and 46 of the preferred embodiment panel 10 and will therefore not be repeated reference to paragraphs 29 through 32 above, being encouraged. Application of adhesive 68 to the first or lower panel 112 and specifically to the uppermost regions 118 of the projecting convolutions 116 may be achieved by the adhesive applying step illustrated in FIG. 4. Alternatively, however, adhesive 68 may be applied directly to the top portions 118 of the convolutions or corrugations116 by an elongate, adhesive distributing horizontal header 128 having a plurality of nozzles 132 spaced apart at distances equal to the spacing of the corrugations 116. The horizontal header 128 also includes a nozzle 134 which applies adhesive 68 to the depending lip 120. The elongate header 128 is provided with adhesive through a flexible hose 136 from a pump 138.

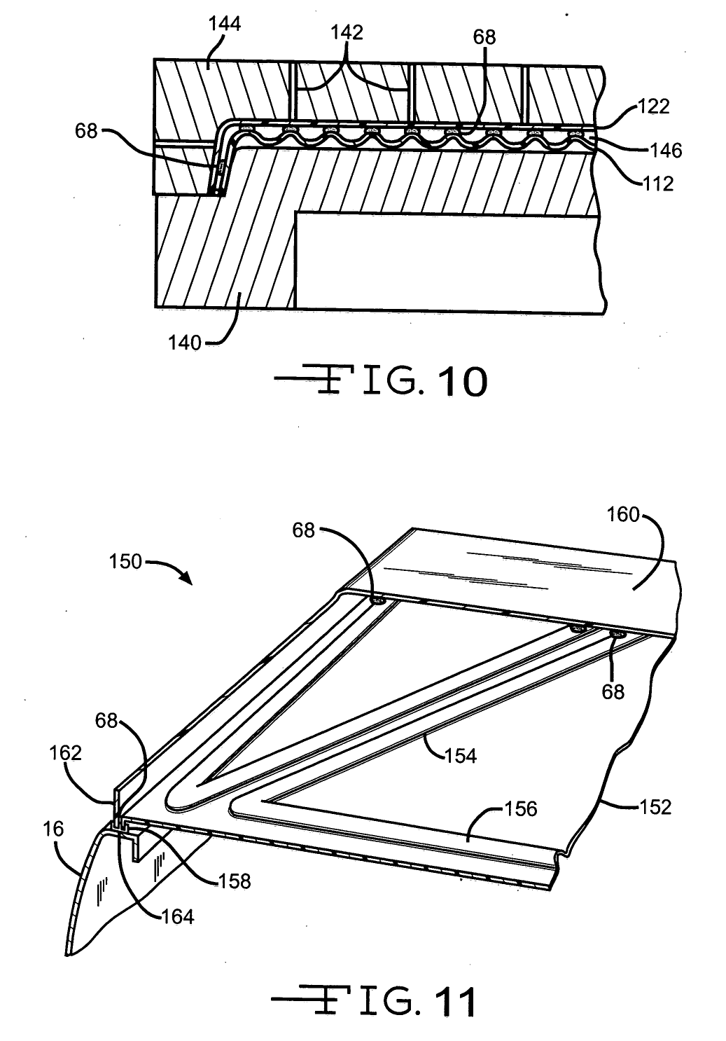

Referring now to FIGS. 9 and 10, subsequent to application of the adhesive 68 to the top portions 118 of the convolutions or corrugations 116 and the exterior of the depending lip 120, the first or lower panel 112 and the second or upper panel 122 are placed within mating mold segments. The first or lower panel 112 is disposed upon a male mold segment 140 and the second or upper panel 122 is disposed upon the first or lower panel 112 or retained by a partial vacuum drawn through passageways 142 on a female or upper mold segment 144. As illustrated in FIG. 9, the mold segments 140 and 144 are brought together to define a mold cavity 146 having a height which suitably compresses the adhesive 68 and intimately bonds the first or lower panel 112 to the second or upper panel 122. The mold segments 140 and 144 are then separated and the first alternate embodiment composite panel 110 may be removed therefrom.

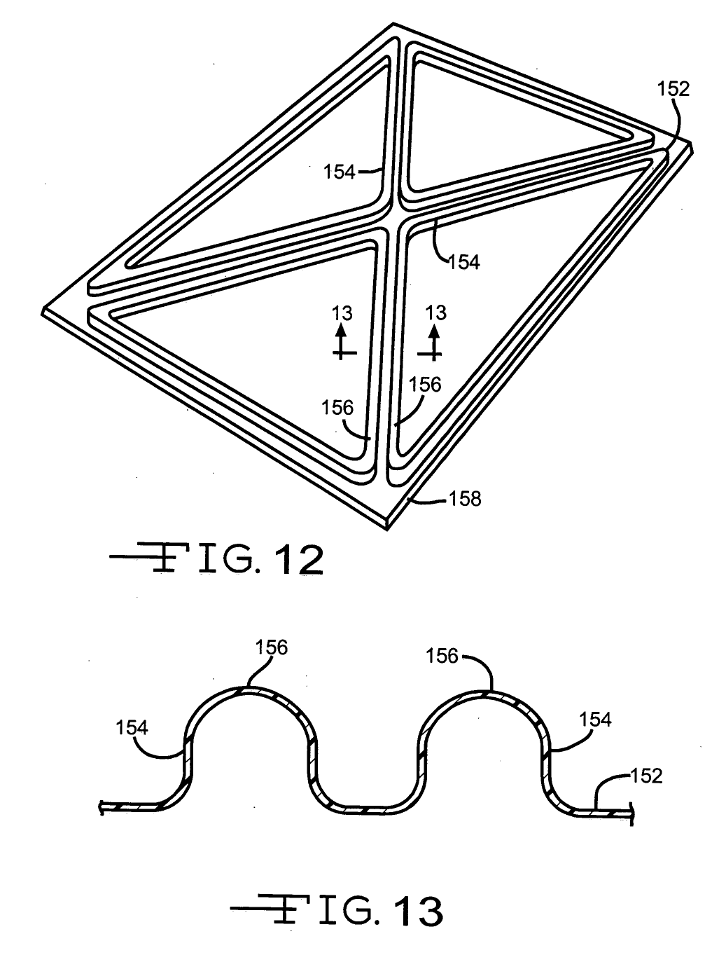

Referring now to FIGS. 11, 12 and 13, a second alternate embodiment composite panel 150 which may be utilized as a tonneau cover or similar product is illustrated. The second alternate embodiment composite panel 150 includes a first or lower panel 152 having a generally X-shaped configuration of convolutions which provide strengthening and improve the rigidity of the composite panel 150. The first or lower panel 152 includes four triangular reinforcing ribs 154 which define an X with closed ends when viewed in plan. Each of the reinforcing ribs 154 is arranged with one side parallel to a peripheral edge of the panel 152 and with four points meeting in the center of the lower panel 152. As illustrated in FIG. 13, convolutions of adjacent reinforcing ribs 154 define a double convolution which produces the X pattern noted above. The top portions 156 of the ribs 154, like the projections in the other embodiments, receive adhesive 68. The first or lower panel 152 also includes a peripheral depending flange or lip 158. Adhesive 68 on the flange or lip 158 and, with the adhesive 68 on the reinforcing ribs 154, secures the first or lower panel 152 to a second or upper panel 160. The second or upper panel 160 also includes a downturned or depending peripheral flange or lip 162. The second alternate embodiment composite panel 150 also includes a U-shaped elastomeric gasket or channel 164 which acts as a cosmetic closure, a bumper and a weatherstrip. It will be appreciated that the first or lower panel 152 and the second or upper panel 160 may be made of HDPE or similar rugged and dimensionally stable thermoplastic according to the process steps described above.

The foregoing disclosure is the best mode devised by the inventors for practicing this invention. It is apparent, however, that products and methods incorporating modifications and variations will be obvious to one skilled in the art of truck beds, bed liners and manufacturing processes therefor. Inasmuch as the foregoing disclosure presents the best mode contemplated by the inventor for carrying out the invention and is intended to enable any person skilled in the pertinent art to practice this invention, it should not be construed to be limited thereby but should be construed to include such aforementioned obvious variations and be limited only by the spirit and scope of the following claims.

1. A method of manufacturing a composite panel comprising the steps of:
forming a first panel having a peripheral lip and a plurality of raised projections defining coplanar surfaces;
forming a second panel having a substantially planar surface and a peripheral lip;
applying an adhesive to at least said coplanar surfaces of said first panel; and
securing said second panel to said first panel with said peripheral lips in substantial proximity.

2. The method of manufacturing a composite panel of claim 1 wherein said raised projections are a plurality of convolutions.

3. The method of manufacturing a composite panel of claim 1 wherein said raised projections are a plurality of frusto-conical projections.

4. The method of manufacturing a composite panel of claim 1 wherein said raised projections are triangles arranged in a closed X pattern.

5. The method of manufacturing a composite panel of claim 1 further including a plurality of elongate projections having a height less than said raised projections.

6. The method of manufacturing a composite panel of claim 1 further including the step of applying adhesive to said peripheral lip of said first panel.

7. The method of manufacturing a composite panel of claim 1 wherein said first and second panels are formed of thermoformable material.

8. A method of manufacturing a composite panel comprising the steps of:
forming a first panel having a peripheral lip and a plurality of raised features;
forming a second panel having a surface and a peripheral lip;
applying an adhesive to at least said raised features of said first panel; and
securing said second panel to said first panel.

9. The method of manufacturing a composite panel of claim 8 further including the step of applying adhesive to one of said peripheral lips.

10. The method of manufacturing a composite panel of claim 9 wherein said raised features are a plurality of convolutions.

11. The method of manufacturing a composite panel of claim 9 wherein said raised features are a plurality of frusto-conical projections.

12. The method of manufacturing a composite panel of claim 9 wherein said raised features are triangles arranged in a closed X pattern.

13. The method of manufacturing a composite panel of claim 9 further including a plurality of elongate features having a height less than said raised features.

14. The method of manufacturing a composite panel of claim 9 wherein said first and second panels are formed of thermoformable material.

15. A composite panel comprising, in combination a first panel having a first peripheral lip and a plurality of raised features;
a second panel having a surface and a second peripheral lip;
adhesive disposed on at least said raised features and one of said peripheral lips; and
said adhesive securing said panels together about three peripheral lips.

16. The composite panel of claim 15 wherein said raised features are a plurality of frusto-conical projections.

17. The composite panel of claim 15 wherein said raised features are a plurality of convolutions.

18. The composite panel of claim 15 wherein said raised features are four triangles arranged in a closed X pattern.

19. The composite panel of claim 15 further including a plurality of elongate features having a height less than said raised features.
